(19) United States
(12) Patent Application Publication
(10) Pub. No.: US 2015/0317683 A1
(43) Pub. Date: Nov. 5, 2015

(54) Navigation-Based Advertisement Targeting

(71) Applicant: Crytek GmbH, Frankfurt/Main (DE)

(72) Inventor: Cevat Yerli, Frankfurt/Main (DE)

(73) Assignee: Crytek GmbH, Frankfurt/Main (DE)

(21) Appl. No.: 14/266,667

(22) Filed: Apr. 30, 2014

(51) Int. Cl. G06Q 30/02

(52) U.S. Cl. CPC G06Q 30/0267; G06Q 30/0261; G06Q 50/01

(57) ABSTRACT

A method for providing information to a user comprises receiving, by a user device, data about a route to be taken by the user, and receiving, by the user device, a selection of a type of information from the user. The method further comprises retrieving, by the user device, information from a database based on the data about the route and the selected type of information, and presenting, by the user device, the retrieved information to the user. Moreover, machine-readable media and mobile user devices are described.

### FIELD

The present disclosure relates to methods and devices for providing information, such as advertisements, to a user. In particular, the methods and devices of the disclosure may be included in a mobile user device.

### BACKGROUND

To allow a user to find a route from a given starting position to a target destination, navigation systems may typically be used. Navigation systems usually allow the user to enter a target destination, for example, via a touchscreen. Based on the entered target destination and a starting position of the user, the navigation system calculates a route and outputs directions, e.g., via a display.

Moreover, in some common navigation systems, additional information is provided to the user. For example, the user may instruct the navigation system to display the location of fuel stations on a map.

However, common navigation systems only provide very few fixed categories of additional information to the user, such as fuel stations, hotels, restaurants, etc. There is, however, an ongoing desire to provide the user with a greater variety of information that is, moreover, adapted to the user's individual interests and requirements.

### SUMMARY AND INITIAL DESCRIPTION

The present disclosure allows the user to be provided with more detailed and more relevant information, such as advertisements, that is better adjusted to the user's interests and needs.

In a first aspect, a method for providing information to a user is provided. The method comprises receiving, by a user device, data about a route to be taken by the user, and receiving, by the user device, a selection of a type of information from the user. The method further comprises retrieving, by the user device, information from a database based on the received data about the route and the selected type of information. The method further comprises presenting, by the user device, the retrieved information to the user.

Some or all of the method steps of the method according to an embodiment of the disclosure may, e.g., be carried out by a mobile user device, such as a navigation device or a smartphone.

In an embodiment of the disclosure, receiving the selection of the type of information comprises receiving a selection of at least one or more of velocity data, data of user's interests, and time related data. In more detail, the method may comprise presenting, by the user device, a list to the user, the list comprising one or more list entries, and the list entries. For example, some of the list entries may refer to a user's interests such as food, drink, or a particular type of food or drink, such as Indian food, Chinese food, or an Irish pub. List entries referring to a service may, e.g., refer to a bank, a hairdresser, or the like.

In an embodiment of the disclosure, the user device comprises a mobile user device. In particular, the user device may comprise, e.g., a mobile phone, a handheld computer, a smartphone, a tablet computer, a laptop computer, a notebook computer, or a watch. In an embodiment, retrieving, by the user device, information from a database is further based on a velocity of the user device, such as, e.g., a current velocity, an average velocity, and/or an expected velocity of the user device. For example, retrieved information of a specific type may, in some instances, only be presented to the user when the user device's velocity is below a first velocity threshold. For example, when the user travels at a low velocity, this may indicate that he or she is interested in his or her surrounding, such as the surrounding landscape, lookout points, historical monuments, museums, etc. The user may thus desire that advertisements for museums are only displayed when the user's velocity is below a first threshold value.

Similarly, in some embodiments, the retrieved information is presented to the user only when the user device's velocity is above a second velocity threshold. For example, when the user travels at a high velocity, this may mean that the user is in a hurry and has, for example, little time for lunch. Accordingly, retrieved information, such as advertisements, related to fast food restaurants on the user's route may, in some instances, only be presented to the user when the user's velocity is above the second velocity threshold. In some embodiments, at least some of the information retrieved from the database comprises advertisements, sponsored designations, and/or recommendations. The advertisement may, e.g., contain an audio advertisement and/or a visual advertisement, such as, e.g., a still image or a video.

In some embodiments, the database stores a plurality of entries, each entry containing a presentable piece of information and a corresponding geographical location. In particular, the step of presenting, by the user device, the retrieved information to the user may comprise presenting, by the user device, the presentable piece of information of an entry retrieved from the database to the user. The geographical location may, e.g., refer to a geographical location of a venue, such as a shop, a restaurant, a bank, etc.

In some embodiments, the step of retrieving, by the user device, information from the database comprises determining a set of entries stored in the database, each entry of the set containing a geographical location that is within a predetermined distance from the user device and/or the route.

In some embodiments, the database is part of a social network, and the user is a member of the social network. The database may, in particular, be modifiable by members of the social network. For example, members of the social network may add, modify, or remove entries from the database. In some embodiments, members of the social network may add, modify, and/or remove the presentable piece of information and/or the corresponding geographical location of at least one entry stored in the database.

In some embodiments, retrieving, by the user device, information from a database comprises retrieving an indication of another member of the social network, and the indication of the other member of the social network comprises at least an identification, such as a name of the other member and/or a current or most recent geographical location of the other member. In this embodiment, the user operating the user device may be presented with the geographical location of other members of the social networks, such as, e.g., friends of the user or members of a group within the social network, to which the user of the user device belongs.

In some embodiments, the step of presenting, by the user device, at least a part of the retrieved information to the user comprises presenting the retrieved information on a display. For example, at least a part of the retrieved information may be presented to the user on a map shown on the display. The display may, e.g., comprise a touchscreen.

Additionally or alternatively, presenting, by the user device, the retrieved information to the user may comprise presenting the retrieved information or at least a part thereof via an audio output of the user device.

In some embodiments, the retrieved information is related to a venue, and presenting the retrieved information to the user comprises presenting at least one of an identification of the venue, a geographical location of the venue, an image of the venue, such as a photo or a drawing of the venue, a logo of the venue, price information related to the venue, service information related to the venue, product information related to the venue, and opening hours related to the venue to the user.

In some embodiments, the step of retrieving, by the user device, information from the database comprises retrieving the information from the database via a wireless interface of the user device. The wireless interface may, e.g., comprise an RF interface.

In some embodiments, the retrieved information refers to a traffic jam along the route reported by at least a predetermined number of other users within a predetermined time interval.

In some embodiments, the retrieved information refers to a speed trap, such as, e.g., a mobile speed trap, along the route reported by at least a predetermined number of other users within a predetermined time interval.

In at least one embodiment, the data about the route to be taken by the user is, at least in part, received through manual entry by the user or selected by the user. In some embodiments, the step of receiving data about the route comprises: receiving a starting position from the user, receiving a target destination from the user, and determining the route based on the starting position and the target destination. Receiving a starting position of the user may, e.g., use a position sensor, such as a GPS sensor. Alternatively or additionally, the step of receiving a starting position of the user may comprise receiving an indication of a starting position from the user, e.g., via an input device, such as a touchscreen. The user may, e.g., specify the starting position manually by entering an address, geographical coordinates, etc., or may select the starting position from a list or indicate the starting position on a map. However, it is preferred that a position sensor is used to detect the starting position.

Alternatively or additionally, the step of receiving an indication of a target destination from the user may comprise receiving the indication of a target destination from the user via an input, such as a touchscreen. In some instances, the user may enter a target destination in the form of an address, geographical coordinates, references, etc. Alternatively or additionally, the user may select a target destination from a list of possible or past target destinations or may enter the target destination by pointing to a position on a map that may, e.g., be shown on a display.

At least a part of the retrieved information may comprise one or more advertisements. While the term “advertisement” may be used in the present description, the skilled person will understand that an advertisement is only one specific category of information that may be used in conjunction with the present disclosure. As used in this disclosure, the term “advertisement” may refer to one or more pieces of information, such as visual, textual, and/or acoustic information.

Depending on the various types of information, the step of presenting the retrieved information to the user may, e.g., comprise presenting the retrieved information via a visual output, such as a display, for example, a touchscreen and/or presenting the retrieved information via an acoustic output, such as loudspeakers or headphones. The retrieved information may, e.g., be associated with a geographical location, such as a shop address, a theater, a museum, a restaurant, a hotel, etc. Alternatively, the retrieved information may be associated with more than one geographical location, such as a plurality of addresses of fast food restaurants of a franchising system.

According to one embodiment, the step of retrieving the information comprises: determining future positions of the user based on the data about the route; and querying the database for the information based on the determined future positions, wherein the database holds a plurality of entries, each entry containing at least a presentable piece of information and one or more corresponding geographical locations. For example, in some instances, the retrieved information may only be presented to the user when a geographical location corresponding to the retrieved information is along the route to be taken by the user or is within a predetermined distance from the route. The database holding the plurality of entries may be provided locally, for example, in a mobile user device of the user and/or may be provided on a server, such as a remote server. In the latter case, the user's mobile user device may comprise an interface for wireless communication with the remote server having a memory storing the database.

In some embodiments, the method further comprises: estimating at least one of an arrival time and a time before arrival at a geographical location corresponding to the retrieved information; and presenting the retrieved information comprises presenting the estimated arrival time or estimated time before arrival, respectively, to the user. In these embodiments, an arrival time and/or a time before arrival may be estimated based on the determined route and the user's velocity. For example, a message may be presented to the user, reading “next fuel station in ten minutes,” e.g., via a display or audio output. The user will thus not only see or hear that he or she is approaching a fuel station, but will also be informed about the estimated arrival time.

The selection of the type of information may be received in the form of one or more URL addresses recently visited by the user, recently played media, such as music and/or videos, existing connections in an online social network, etc. For example, when the user frequently listens to music by Elvis Presley, he or she will be informed about a rock'n′roll museum that is along his or her route. Receiving the selection of the type of information may comprise receiving the selection via a wireless network and/or the Internet. Alternatively or additionally, the user may select specific types or select one or more types from a given list, as described above.

According to one embodiment, the method further comprises: determining a current or future geographical location of a friend of the user; and retrieving the information is further based on the determined current or future geographical location of the user's friend. The term “friend” may, for example, refer to a friend of the user in an online social network or a member of the same group as the user operating the user device. For example, a friend may be any person to which the user has a direct or possibly indirect connection in a social network. In some cases, the term “friend” may also comprise persons, organizations, bands, social groups, or other entities that the user is a friend, follower, customer, or fan of, as expressed in the online social network. For example, when the user has indicated in an online social network that he or she is a fan of the famous rock band A, the user may be informed that the rock band A will be playing a concert tonight at a venue close to the user's planned route. One or more further details, such as estimated arrival time at the venue, starting time for the concert, ticket prices, etc., may also be presented to the user.

In at least one embodiment, the step of presenting the retrieved information is performed when a geographical location corresponding to the retrieved information is on or within a predetermined distance from the route. The predetermined distance may, in some instances, be adjustable by the user, for example, based on a specific type of product or service, such as hotels, restaurants, etc., or may be globally adjusted for any type of information. Additionally or alternatively, the predetermined distance may be associated with the retrieved information. For example, the database holding a plurality of entries may further hold a predetermined distance for each or some of the plurality of entries. For example, the user may specify that information related to fast food restaurants will only be presented when the fast food restaurant is within a relatively short predetermined distance, such as within half a mile, from the route. At the same time, the user may wish that information related to national monuments may be presented to the user when the national monument is within a relatively long distance of ten miles from the route.

In at least one embodiment, the step of presenting the retrieved information is performed when an estimated time before arrival at a geographical location corresponding to the retrieved information is within a predetermined time interval. For example, the user may specify that information related to fast food restaurants will only be presented to the user when the fast food restaurant is less than 15 minutes away, based on the user device's velocity and the determined route. The predetermined time interval may, in some instances, be adjustable by the user. Alternatively or additionally, the predetermined time interval may be stored in the database holding. In particular, different predetermined time intervals may be associated with different entries of the database or different types of information.

In a further aspect, the present disclosure provides a non-transitory machine-readable medium having instructions stored thereon that, in response to execution by a user device, cause the user device to perform any of the aforementioned methods. The user device may be in the form of a user computing device, such as a smartphone, a hand-held device, a laptop, a navigation device, or the like.

In a further aspect, a mobile user device is provided that comprises a route interface adapted for receiving data about a route to be taken by a user, a user interface adapted for receiving a selection of a type of information, e.g., from the user, a data interface adapted for retrieving information from a database based on the data about the route and the selected type of information, and an output adapted for presenting the retrieved information to the user.

The route interface, the user interface, and the data interface may, for example, be implemented using the same integrated circuit (IC). In some embodiments, the output comprises at least one of a display and acoustic output, such as a loudspeaker, a set of loudspeakers, headphones, etc. The display may, for example, be a touchscreen.

The database may be incorporated into a remote server or be coupled thereto, or may be incorporated into the user device. The data interface may be adapted to be in wireless and/or wired communication with the database and/or the remote server. In some instances, the database is located at a remote server that is coupled in wired or wireless communication with the user device via the data interface of the user device and a corresponding data delivery interface of the server.

According to one embodiment, the data interface is adapted to be in wireless communication with the database. For example, in some embodiments, the data interface comprises a wireless transceiver, in particular, an RF transceiver.

In some embodiments, the database is part of a social network, and the user is a member of the social network, as has been explained in more detail above.

In some embodiments, the mobile user device further comprises a velocity sensor adapted for determining a velocity of the user device. In these embodiments, the data interface may be adapted for retrieving the information from the database further based on a current velocity, an average velocity, and/or an expected velocity of the user device.

According to one embodiment, the data interface is further adapted to estimate at least one of an arrival time and a time before arrival at a geographic location corresponding to the retrieved information, and the estimated arrival time or the estimated time before arrival, respectively, is presented via the output. In particular, the data interface may estimate the arrival time or the time before arrival based on a velocity detected by a velocity sensor and the route.

According to one embodiment, the retrieved information is presented via the output when at least one of the following conditions applies: a geographical location corresponding to the retrieved information is on the route; and a distance between a geographical location corresponding to the retrieved information and the route is within a predetermined maximum distance from the route. A distance between a geographic location and the route may, in particular, correspond to the shortest distance between the geographic location and any of the positions constituting the route, e.g., each point of the route.

According to one embodiment, the retrieved information is presented via the output when at least one of the following conditions applies: an estimated time before arrival at a geographical location corresponding to the retrieved information is within a predetermined time interval; and an estimated time before arrival within a predetermined distance from a geographical location corresponding to the retrieved information is within a predetermined time interval.

Additionally or alternatively, the retrieved information may be presented via the output when at least one of the following conditions applies, based on user selection: the retrieved information matches a user's interest; a user's friend is currently within a predetermined distance from a geographical location corresponding to the retrieved information; a user's friend is expected to be within a predetermined distance from a geographical location corresponding to the retrieved information within a predetermined future time interval; the retrieved information has been updated within a predetermined past update period; the retrieved information corresponds to a predetermined type of information; the retrieved information has been previously recommended by a user's friend in an online environment, such as a social network; the retrieved information offers a discount; and the detected velocity is below or above a predetermined velocity threshold.

Whether a user's friend is currently at a specific geographical location or is expected to be at a specific geographical location may, e.g., be determined based on a geographical position indicated by that friend within an online environment. For example, one of the user's friends may post his or her geographical coordinates via his or her smartphone on a certain web page or in a social network, or may otherwise indicate his or her current geographical location. Similarly, the user's friend may indicate in a social network that he or she intends to go to a particular venue, such as, e.g., a restaurant, that night. The user's mobile user device may receive such information from the social network via a data interface as specified above and may use this information to determine the information to be presented to the user.

### BRIEF DESCRIPTION OF THE DRAWINGS

The present disclosure is illustrated by way of example and not intended to be limited by the figures of the accompanying drawings.

FIG. 1 is a schematic diagram of a route to be taken by a user;

FIG. 2 illustrates an embodiment of a flow diagram of a method for providing information to a user;

FIG. 3 illustrates an embodiment of an illustrative mobile user device; and

FIG. 4 illustrates a server that may be used in conjunction with the mobile user device of FIG. 3.

### DETAILED DESCRIPTION

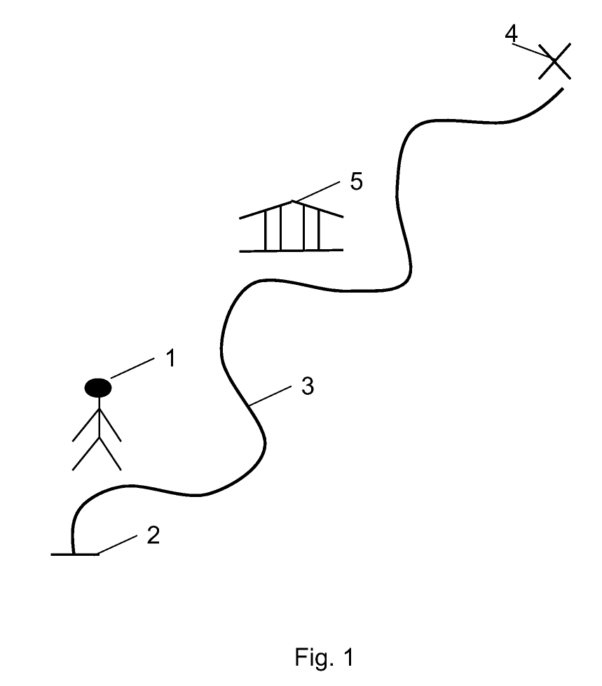

FIG. 1 shows a schematic diagram of a user 1, who is on the way to a target destination 4. The user 1 may have started his route at a starting position 2. For example, the user 1 may have entered his or her desired target destination 4 in a mobile user device according to an embodiment of the disclosure. The mobile user device may, for example, further comprise a position sensor, such as a GPS sensor, to automatically determine the user's starting position 2, which may be the user's current position while the user enters the target destination. Alternatively, the user 1 may have manually entered his or her starting position 2.

In response to receiving an indication of the target destination 4 from the user 1, the mobile user device determines, e.g., calculates, a route 3 from the starting position 2 to the target destination 4. The route 3 may, e.g., correspond to a shortest travelling distance from the starting position 2 to the target destination 4. In other embodiments, the user device may have received the data about the route from a separate, e.g., external device, such as, e.g., a navigation system. The mobile user device may, for example, be a handheld device, such as a smartphone, or may be a dedicated navigation device, a laptop, etc. In some instances, the mobile user device is a navigation device fixedly built into a vehicle, such as a passenger car.

When the user 1 follows the route 3, the mobile user device repeatedly queries a database for information that may be of relevance for the user 1. In some instances, the mobile user device may query the database on a periodic basis, such as with a period of between 10 ms and 5 minutes, in particular, between 500 ms and 3 minutes, preferably between 1 s and 2 minutes and, even more preferred, between 30 s and 1 minute.

For example, the mobile user device may determine that a museum 5 is close to the route 3 taken by the user 1, which currently offers a discount. The mobile user device may then check whether the museum 5 is within a predetermined, user-specified distance from the route 3. When this is the case, the mobile user device may present information, such as, e.g., an advertisement associated with the museum 5 to the user 1, for example, via a display integrated into the mobile user device. Moreover, the mobile user device may determine a time, when the advertisement is to be presented to the user 1, based on a predetermined time interval associated with the advertisement of the museum 5. For example, the mobile user device may determine a current velocity of the user 1 and estimate a time before arrival of the user 1 at the museum 5. When the estimated time before arrival is within, e.g., less than, a predetermined time interval associated with the advertisement, the mobile user device may present the advertisement to the user 1.

Additionally or alternatively, the mobile user device may only present the information associated with the museum 5 to the user 1 when the current velocity of the user device is below a first velocity threshold, as this may indicate that the user is interested in receiving information about cultural venues, and/or when the user has specified that he or she wishes to be informed about museums.

Additionally or alternatively, the user 1 may have instructed the mobile user device to only present an advertisement when there is a discount associated with that advertisement. For example, the advertisement associated with the museum 5 may indicate that visitors arriving today will receive a 20% discount on the entrance fee. Accordingly, the mobile user device may present the advertisement associated with the museum 5 to the user 1.

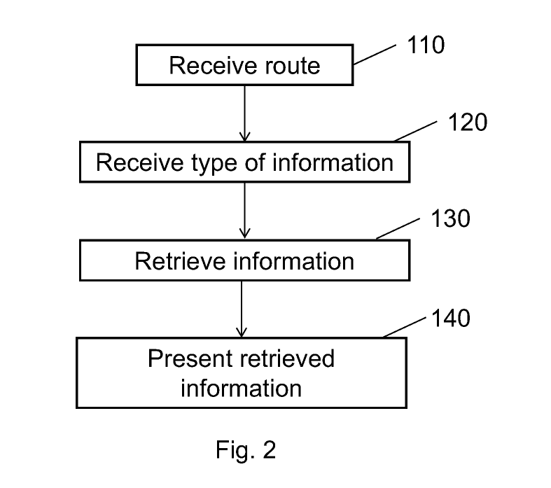

FIG. 2 illustrates an embodiment of a flow diagram for a method for providing advertisements to a user. At block 110, data about a route is received. For example, the user, such as user 1 of FIG. 1, may have entered a target destination. Based on a starting position, which may correspond to a user's current position, a route to the target destination entered by the user may be determined and be received in block 110. In an alternative embodiment, the mobile user device receives the data about the route to be taken by the user from another device, such as, e.g., an external navigation system, a server or the like.

After the data about the route have been received in block 110, the method proceeds to block 120, in which a selection of a type of information is received by the user device. While steps 110 and 120 are presented in sequence in FIG. 2, the skilled person will understand that, in alternative embodiments, step 120 may be performed before 110, or at substantially the same time as step 110.

Following block 120, information is retrieved from a database based on the received data about the route and the selected type of information. The retrieved information 130 is then presented to the user in block 140.

In some instances, the method then returns to block 110 or to block 120. For example, all or some of the method steps of FIG. 2 may be repeated on a periodic basis, as previously described.

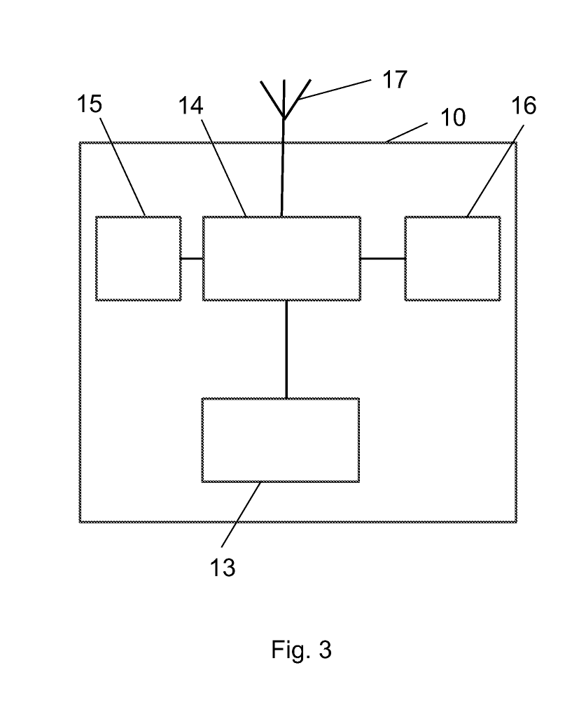

FIG. 3 illustrates an embodiment of an illustrative mobile user device 10. The mobile user device comprises a route interface 13 adapted to receive data about a route to be taken by the user by the mobile user device. This may, e.g., comprise determining the route associated with the shortest time, shortest travelling distance, the least traffic, the most scenic views, or the like, from a starting position to a target destination. The route logic 13 further provides the data about the route, such as future positions, to a data interface 14 of the mobile computing device 10. The data interface 14 is further coupled to a user interface 15 for receiving a selection of the type of information that the user is interested in. Based on the route received from the route interface 13 and the type of information received from the user interface 15, the data interface 14 retrieves information from a database and presents the retrieved information via output 16 of the mobile computing device 10. The output 16 may, for example, comprise a display and/or acoustic output.

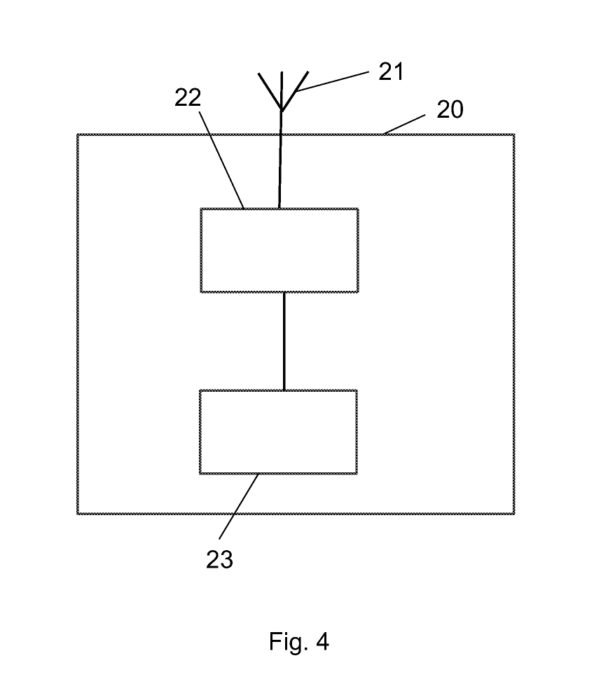

In order to retrieve the information, the data interface 14 may be further coupled to an antenna 17 adapted for wireless communication with a server. For example, the data interface 14 may send details of the route received from the route interface 13, such as future positions, and possibly the current velocity of the mobile user device 10, via the antenna 17 to a remote server, such as remote server 20 shown in FIG. 4, having a memory 23 that stores the database holding a plurality of entries, each entry containing a piece of information and a corresponding geographical location. In return, the data interface 14 may receive a set of information via the antenna 17 from the remote server 20, and present the retrieved information via the output 16.

In an alternative embodiment, the mobile user device 10 may additionally or alternatively comprise a local memory (not shown) storing the database holding the plurality of entries and coupled to the data interface 14. The local memory may be present in addition to or alternatively to the antenna 17.

FIG. 4 illustrates a remote server 20 that may be used in conjunction with the mobile user device 10 of FIG. 3. The remote server 20 comprises a memory 23 that stores the database holding the plurality of entries. The database may hold one or more geographical locations for each of the stored pieces of information. In some embodiments, the database stored in memory 23 may further hold a predetermined distance for each or at least some of the stored geographical locations. Accordingly, the mobile user device 10 may, in some instances, only present a particular piece of information to the user when a geographical location associated with that particular piece of information is less than the predetermined distance away from the route and/or the mobile user device's current position.

Similarly, the database stored in memory 23 may further hold a predetermined time interval for each or at least some of the stored entries. Accordingly, the mobile user device 10 may, in some instances, only present a particular piece of information to the user when a geographical location associated with that particular piece of information is less than the predetermined time interval away from the mobile user device's current position along the route.

The server 20 may further have a data delivery interface 21 that may, e.g., be an RF interface adapted for wireless communication with the antenna 17 of the mobile user device 10, as, e.g., shown in FIG. 3. The remote server 20 further comprises a processor 22 communicatively coupled to the memory 23 and the data delivery interface 21. The processor 22 processes queries from the mobile user device 10 received via the data delivery interface 21 and accordingly searches the database stored in memory 23 for pieces of information matching the received type of information and corresponding geographical locations. When one or more matching pieces of information are found in the database, the processor 22 forwards the one or more matching pieces of information along with the corresponding geographical location(s) and possibly predetermined distances and/or predetermined time intervals via the data delivery interface 21 to the mobile user device 10. In the foregoing specification, a detailed description has been given with reference to specific exemplary embodiments. It will, however, be evident to the skilled person that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiments and similar language does not necessarily refer to the same embodiment, but may refer to different embodiments, as well as potentially the same embodiment.

1. A method for providing information to a user, comprising:
receiving, by a user device, data about a route to be taken by the user;
receiving, by the user device, a selection of a type of information from the user;
retrieving, by the user device, information from a database based on the data about the route and the selected type of information; and
presenting, by the user device, the retrieved information to the user.

2. The method of claim 1, wherein receiving the selection of the type of information comprises receiving a selection of at least one or more of velocity related data, data of user's interests, and time related data.

3. The method of claim 1, wherein the user device comprises a mobile user device, a mobile phone, a handheld computer, a tablet computer, a navigation device, a laptop computer, a notebook computer, or a watch.

4. The method of claim 1, wherein retrieving, by the user device, information from a database includes retrieving information from a database that comprises sponsored destinations, advertisements, and/or recommendations.

5. The method of claim 2, wherein the velocity related data refer to a current velocity, an average velocity, and/or an expected velocity of the user device.

6. The method of claim 1, wherein the database stores a plurality of entries, each entry containing a presentable piece of information and a corresponding geographical location.

7. The method of claim 6, wherein retrieving, by the user device, information from the database comprises determining a set of entries stored in the database, each entry of the set containing a geographical location that is within a predetermined distance from the user device and/or the route.

8. The method of claim 1, wherein the database is part of a social network, wherein the user is a member of the social network.

9. The method of claim 8, wherein retrieving, by the user device, information from a database comprises retrieving an indication of another member of the social network, wherein the indication of the other member of the social network comprises at least a name of the other member and/or a current or most recent geographical location of the other member.

10. The method of claim 1, wherein presenting, by the user device, the retrieved information to the user comprises presenting at least part of the retrieved information on a display.

11. The method of claim 1, wherein the retrieved information is related to a venue, and wherein presenting the retrieved information to the user comprises presenting at least one of an identification of the venue, a geographical location of the venue, an image of the venue, a logo of the venue, price information related to the venue, service information related to the venue, product information related to the venue, and opening hours related to the venue to the user.

12. The method of claim 1, wherein retrieving, by the user device, information from the database comprises retrieving the information from the database via a wireless interface of the user device.

13. The method of claim 1, wherein the retrieved information refers to a traffic jam along the route reported by at least a predetermined number of other users within a predetermined time interval.

14. The method of claim 1, wherein the retrieved information refers to a speed trap along the route reported by at least a predetermined number of other users within a predetermined time interval.

15. A non-transitory machine-readable medium having instructions stored thereon that, in response to being executed by a user device, cause the user device to perform the method of claim 1.

16. A mobile user device comprising:
a route interface adapted for receiving data about a route to be taken by a user;
a user interface adapted for receiving a selection of a type of information;
a data interface adapted for retrieving information from a database based on the data about the route and the selected type of information; and
an output adapted for presenting the retrieved information to the user.

17. The mobile user device of claim 16, wherein the output comprises a display.

18. The mobile user device of claim 16, wherein the data interface is adapted to be in wireless communication with the database.

19. The mobile user device of claim 16, wherein the database is part of a social network, and wherein the user is a member of the social network.

20. The mobile user device of claim 16, further comprising a velocity sensor adapted for determining a velocity of the user device, and wherein the data interface is adapted for retrieving the information from the database further based on a current velocity, an average velocity, and/or an expected velocity of the user device.
